(19) United States
(12) Patent Application Publication
(10) Pub. No.: US 2023/0267533 A1
(43) Pub. Date: Aug. 24, 2023

(54) System and method for toll bidding

(71) Applicant: Mapup Inc, SUNNYVALE, CA (US)

(72) Inventors: Maneesh Mahlawat, MOUNTAIN VIEW, CA (US); Kirti Mahlawat, MOUNTAIN VIEW, CA (US); Mohit Bahadur Singh, Milpitas, CA (US); Venkatesh Nellore, Tirupati (IN)

(73) Assignee: Mapup Inc, SUNNYVALE, CA (US)

(21) Appl. No.: 17/676,241

(22) Filed: Feb. 21, 2022

(51) Int. Cl. G06Q 30/08; G06Q 30/02

(52) U.S. Cl. CPC G06Q 30/08; G06Q 30/0283; G06Q 2240/00

(57) ABSTRACT

A method performed by a platform for dynamically adjusting a toll price of a toll road. The method includes receiving a plurality of inputs to estimate congestion on a toll road. The method further includes receiving a request from one or more users to provide prices of the toll road. Once the plurality of inputs are received, the method includes estimating the congestion on the toll road. Based on the estimated congestion on the road and historical toll bidding information, the method includes determining an initial toll price at the toll road for each of the one or more users. The initial prices are then notified to respective users to receive their real-time toll bidding responses. Based on the received real-time toll bidding responses, the method includes dynamically adjusting the respective initial toll price for the toll road.

### FIELD OF THE INVENTION

The present invention relates to a system and method for toll bidding, and more specifically to a system and method for dynamic toll bidding resulting in optimal road utilization and enhanced commuter experience.

### BACKGROUND OF THE INVENTION

With rapid urbanization and increasing population, the problem of traffic congestion has become widespread throughout the world. The problem exacerbates during peak traffic hours, e.g. morning office or school times, leading to delays and traffic snarl on the roads. From the commuters' perspective, traffic congestion results in longer travel time and unpredictability in the time of the travel. Additionally, constant traffic congestion results in financial losses and emotional pain, leading to road rage incidents, for the commuters. For example, it leads to a loss of valuable time and billions of dollars of fuel consumed by automobiles stuck in traffic jams. Further, at times, due to traffic congestion, commuters miss important appointments, such as flights or meetings, which further adds to their frustration.

From the perspective of the regulatory bodies or the firms handling traffic management, traffic congestion is undesirable. It leads to a suboptimal road utilization, which can lead to traffic jams in one part of the road network, while the other may be underutilized.

It is expected that in the coming years, due to autonomous vehicles and lower costs of travel, more automobiles will ply on the roads and existing vehicles will travel more miles leading to increased congestion.

Regulatory agencies and traffic management firms have tried different methods and processes to address the issue of traffic congestion. One of the widely utilized ways is to regulate traffic using variable toll rates on toll roads. For example, the toll rates are decided in advance based on historical information of traffic peaks during different times of the day, and road agencies set different toll rates for different times of the day. As an example, higher toll rates are set during peak office hours. This way, the higher tolls dissuade commuters from using the toll roads during the peak office hours. For example, due to higher toll rates, a few commuters change their route away from the toll road and avoid using the toll road. This does help regulate the traffic somewhat, however this approach has not been overly successful till date. This is because the existing systems mostly use the information of the historical traffic data to set toll rates, which may not always work in all traffic situations.

Thus, there is a need for a system and method to effectively regulate traffic on the road that results in optimal road utilization, enhanced commuter experience, and no financial losses for the commuters or the traffic management firms.

### SUMMARY OF THE INVENTION

The present invention is directed towards a platform for dynamically adjusting a toll price for a toll road. The platform includes a transceiver that is configured to receive a plurality of inputs to estimate congestion on the toll road. The transceiver may be further configured to receive a request from one or more users to provide prices of the toll road.

The platform further includes a processor that is communicatively coupled to the transceiver. The processor may be configured to estimate, based on the plurality of inputs, the congestion on the toll road. The processor may be further configured to determine, for each of the one or more users, an initial toll price at the toll road based on the estimated congestion on the toll road and historical toll bidding information. The historical toll bidding information comprises bidding responses from a plurality of users on different toll prices at different toll roads in the past.

Once the initial toll price is determined, the transceiver may be further configured to notify the respective initial toll price to each of the one or more users via their respective user devices, and receive real-time toll bidding responses from the respective user devices associated with the one or more users on the respective initial toll price. Based on the real-time toll bidding responses, the processor may be further configured to dynamically adjust the initial toll price for the toll road, for each of the next one or more users.

In accordance with an embodiment of the present invention, the transceiver may be further configured to notify the respective adjusted toll price to each of the next one or more users, and receive further real-time bidding responses on the adjusted toll price.

In accordance with an embodiment of the present invention, the plurality of inputs may include real time traffic information, user behavior, historical traffic information, accident information, weather patterns, time of the day, schedule of flight, transit, and events, usage of water, electricity and gas, traffic on complementary and competing roads, and their combination thereof.

In accordance with an embodiment of the present invention, user behavior may include one or more of: frequency of usage of toll roads for different routes, purpose of travel, number of vehicles registered to a user profile, location of the destination, and value of time of the user.

In accordance with further embodiments of the present invention, the processor may be configured to recommend one or more of time and route to a user, of the one or more users, based on the plurality of inputs and the real-time toll bidding responses.

In accordance with further embodiments of the present invention, the transceiver may be configured to receive a first request to provide a clear passage at the toll road. The first request may be received from one or more of an emergency vehicle, a police vehicle, and a fire brigade. Based on the received first request, the processor may be further configured to dynamically adjust the initial toll price for the next one or more users.

In accordance with further embodiments of the present invention, the transceiver may be configured to receive a second request to move a large number of vehicles through the toll road. Based on the second request, the processor may be further configured to notify one or more of: an estimated congestion at different times, a capacity of the toll road at different times to handle the movement of the large number of vehicles, recommendation of route and time based on the plurality of inputs and real-time bidding responses.

The present invention is further directed towards a method, performed by a platform, for dynamically adjusting a toll price for a toll road. The method includes receiving a plurality of inputs to estimate congestion on a toll road. The method further includes receiving a request from one or more users to provide prices of the toll road. Once the plurality of inputs are received, the method includes estimating the congestion on the toll road. Based on the estimated congestion on the road and historical toll bidding information, the method includes determining, for each of the one or more users, an initial toll price at the toll road. The historical toll bidding information comprises bidding responses from a plurality of users on different toll prices at different toll roads in the past. After the determination of the initial toll price, the method includes notifying the initial toll price to each of the one or more users via their respective user devices. In response to the notification, the method includes receiving real-time toll bidding responses from the respective user devices associated with the one or more users on the respective initial toll price. Based on the real-time toll bidding responses, the method includes dynamically adjusting the initial toll price for the toll road, for each of the next one or more users.

The method further includes notifying the adjusted toll price to each of the next one or more users, and receiving further real-time bidding information on the adjusted toll price.

In accordance with an embodiment of the present invention, the plurality of inputs comprise real time traffic information, user behavior, historical traffic information, accident information, weather patterns, time of the day, schedule of flight, transit, and events, usage of water, electricity and gas, traffic on complementary and competing roads, and their combination thereof.

In accordance with an embodiment of the present invention, the user behavior includes one or more of: frequency of usage of toll roads for different routes, purpose of travel, number of vehicles registered to a user profile, location of the destination, and value of time of the user.

In accordance with further embodiments of the present invention, the method includes recommending one or more of time and route to a user, of the one or more users, based on the plurality of inputs and the real-time toll bidding responses.

In accordance with further embodiments of the present invention, the method includes receiving a first request to provide a clear passage at the road associated with the toll road. The first request may be received from one or more of an emergency vehicle, a police vehicle, and a fire brigade. Based on the received first request, the method includes dynamically adjusting the initial toll price for the next one or more users.

In accordance with further embodiment of the present invention, the method includes receiving a second request to move a large number of vehicles through the toll road. Based on the second request, the method includes notifying one or more of: an estimated congestion at different times, a capacity of the toll road at different times to handle the movement of the large number of vehicles, recommendation of route and time based on the plurality of inputs and real-time bidding responses.

### BRIEF DESCRIPTION OF THE DRAWINGS

FIG. 1 illustrates an environment where the present invention may be implemented, in accordance with an embodiment of the present invention.

FIG. 2 illustrates one or more inputs used by a platform for dynamically adjusting a toll price for a toll road for a user, in accordance with an embodiment of the present invention.

FIGS. 3A and 3B illustrate a summarized view of the steps performed by the user and the platform to enable dynamic adjusting of the toll prices by the platform.

FIG. 4 illustrates a block diagram of the platform for dynamically adjusting the toll price for the toll road, in accordance with an embodiment of the present invention.

FIG. 5 illustrates a method for dynamically adjusting the toll price for the toll road, in accordance with an embodiment of the present invention.

### DETAILED DESCRIPTION

Hereinafter, the preferred embodiments of the present disclosure will be described in conjunction with the accompanying drawings. It should be understood that the preferred embodiments described herein are only used to illustrate and explain the present disclosure and are not intended to limit the present disclosure.

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

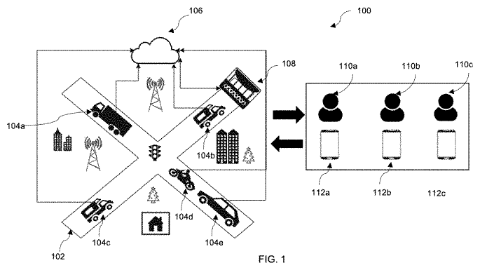

FIG. 1 illustrates an environment 100 where the present invention may be implemented, in accordance with an embodiment of the present invention. The environment 100 may include a road network 102 on which one or more vehicles 104a, 104b, 104c, 104d, and 104e (collectively referred to as vehicles 104 from hereon) ply. The vehicles 104 may include, for example, large cargo vehicles, trucks, cars, bikes, pickup trucks, etc.

Each of the vehicles 104 may be connected to a server 106 through a telecommunication network (not shown). In an exemplary embodiment, the vehicles 104 may send their location information to the server 106. As an example, the vehicles 104 may have Global Positioning Systems (GPS) installed in them, and the server 106 may receive the location information from the GPS installed in the vehicles 104. The server 106 may collate the location information of the vehicles 104 to estimate real-time traffic flow or road usage of the road network 102.

A person ordinarily skilled in the art may appreciate that even if a few of the vehicles 104 are not installed with the GPS, the server 106 may still determine the expected road usage by using existing map, or navigation technologies. For example, one the existing commercial navigation service providers is Google Maps™, and the server 106 may receive road usage information from the said or similar service providers. In accordance with further embodiments of the present invention, the road network 102 may be installed with a plurality of smart cameras and sensors that feed real-time traffic information to the server 106, so that the server 106 can estimate the real-time road usage. Also, the server 106 may receive real-time vehicle movement information from devices located inside the vehicles 104, e.g. mobile phones associated with the users of the vehicles 104 or car infotainment systems, and the like, to estimate the road usage of the road network 102.

Based on the estimation of the real-time road usage, the server 106 may estimate any potential traffic congestion on a particular road and may take preventive steps to achieve optimal road utilization of the road network 102. As an example, if high congestion is estimated on a particular road, some of the vehicles may be incentivized to take other roads, which are less likely to be congested.

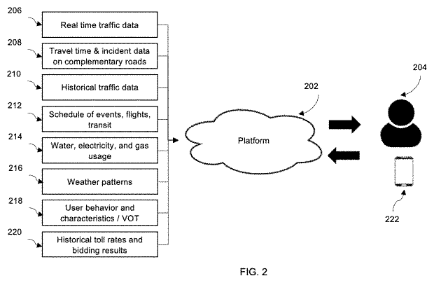

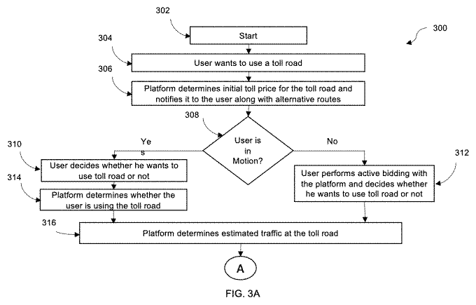

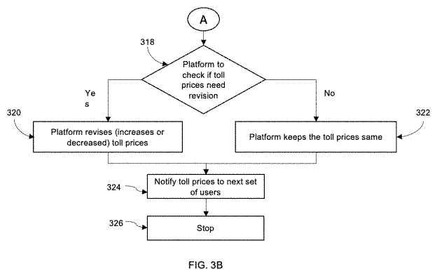

While the scenario mentioned above explains the usage of only real-time traffic or road usage information as an input by the server 106 to estimate potential traffic congestion, the present invention utilizes a number of additional inputs to estimate traffic congestion. These additional inputs and the concept of regulating the traffic to avert traffic congestions and achieve optimal road utilization are briefly explained below, and explained in detail in conjunction with FIGS. 2, 3A and 3B.

In accordance with an embodiment of the present invention, the server 106 may be configured to achieve optimal utilization of the road network 102 by varying toll prices for one or more toll roads present in the road network 102. The toll road may include a toll station 108 or may include a stretch of road or zone (not shown in FIG. 1) for which the user is required to pay toll prices for using the toll road. For instance, if it is determined by the server 106 that a traffic congestion may happen on a particular toll road, the toll price for the toll road may be revised upwards in real-time. This will dissuade the users who are planning to take the toll road from taking the said road for their trip, and they may opt for another route. This way, the traffic may get regulated on the toll road, and hence the congestion may be averted.

In accordance with an embodiment of the present invention, the server 106 may be configured to vary the toll prices that may be different for different vehicle types, and may also be different for different times of the day. For example, the toll prices may be higher for cargo vehicles, and may be lower for personal cars or bikes. Also, the toll prices may be higher during peak office times, or may even be variable based on the number of occupants in a vehicle. In addition, the toll prices may vary from user to user (even if they are driving the same type of vehicle). For example, the toll prices may vary based on a number of factors, such as, but not limited to, real time road usage information (e.g. by using the real-time traffic information, as mentioned earlier), individual user behavior, historical traffic information, accident information, weather patterns, time of the day, schedule of flight, transit, schedule of events, usage of water, electricity and gas, traffic on complementary and competing roads, historical toll bids, user characteristics, and their combination thereof. Detailed explanation of these factors and how they are used to determine customized toll prices for each user is provided in the description of FIG. 2.

A person ordinarily skilled in the art may appreciate that the factors mentioned above are mere examples, and more or less factors may be used to dynamically decide the toll prices of a toll road for different users, without departing from the scope of the present invention. The examples mentioned above should not be construed as limiting the scope of the present invention. Additionally, there could be other considerations as well to revise upwards (or downwards) the toll prices of one or more toll roads, e.g. revenue targets of the traffic management firm managing the road network 102, special requests from emergency vehicles like police vehicles, ambulances, fire brigades, etc. A few of these additional considerations are explained in conjunction with FIG. 2.

Typically, the toll price for a toll road is shown to the users of the vehicles 104 in advance, so that they know the amount that they are expected to pay. The toll price may be deducted automatically by user device of the user of the vehicle 104, or may be paid manually by the user which entering or exiting the toll road.

In accordance with an embodiment of the present invention, the server 106 may be configured to send the toll prices to the users on their respective user devices. These user devices may include, but are not limited to, mobile phones, laptops, tablets, smart watches, in-vehicle infotainment systems, and the like.

An exemplary embodiment is shown in FIG. 1, where different users 110 (110a, 110b, 110c) are shown their respective toll prices on their mobile phones 112 (112a, 112b, 112c). A few of the users 110 may be stationary, and a few may be driving one or more vehicles 104. For example, a few users of the users 110 may not be driving, but may be planning a trip for the future that may involve using the toll road of the road network 102. In this case, the user may input the “start location” of his trip, the “destination location” and time of the trip, on an Application (app) installed on the user device (mobile phone 112). In accordance with an embodiment of the present invention, the server 106 may be configured to receive the user input, and send the toll prices and estimated time of the travel to the app. In accordance with further embodiment of the present invention, the server 106 may be configured to send information about multiple routes and their respective travel times and toll prices to the app. In addition, the toll prices for the different toll roads that are there in his route may be sent to the app. Based on the sent toll price, the user may be able to “bid” on the toll price. In other words, the user may be enabled to “accept” or “reject” the toll price that is shown to him on the app. Here, “reject” means that the user may decide to take a different road (competing road) for his trip, as the shown toll price may be outside of his budget. “Accept” would mean that the user is fine with paying the shown toll price.

In accordance with an embodiment of the present invention, the user may provide his response (accept/reject) on the bid shown on the app using touchscreen or keypad of the user device or using voice commands, eye or face movement tracking, and the like.

In accordance with an embodiment of the present invention, while the users who are not on the road (i.e. not driving) are shown the respective toll prices and they can bid on the app, the users who are driving are not given an option to bid on the app. These users are simply shown the toll price on the app, and they may pay the price for the toll road. In other words, to avoid accidents, the app may restrict users from bidding for the toll prices while they are driving, and may only accept bids when they are stationary. Also, when the user is already driving on the toll road, it may not be possible for him to change the road midway, and hence “rejecting” the shown toll price may not even be an option for the user.

Based on the real-time bidding responses of the user (and other users who have shown interest to use the road network 102), the server 106 may be further configured to update the estimation of the traffic congestion for the future, and may dynamically adjust the toll prices based on the updated estimation. For example, the server 106 may determine that a lot of users are accepting the bid. Based on this determination, the server 106 may estimate high congestion on the road for the future, and hence the server 106 may increase the toll prices for the next set of bids (i.e. for the next set of users who show interest in using the toll road). Alternatively, if lots of users are declining the bid, the server 106 may decrease the toll prices for the next set of bids to achieve optimal road utilization and to avoid loss of substantial revenue for the traffic management firm managing the road network 102.

As mentioned above, the toll prices are shown on the app installed on the user devices 108 of the users 110, and the said toll prices are sent by the server 106. In accordance with an embodiment of the present invention, the app may receive the toll prices in real time from a dedicated platform that may be hosted on the server 102, and that dynamically updates the toll prices for different users that are using the road network 102. The said platform would be described in detail in conjunction with subsequent figures.

FIG. 2 illustrates one or more inputs used by a platform 202 for dynamically adjusting the toll price for a toll road, for a user 204, in accordance with an embodiment of the present invention. As described earlier, the toll price that is shown to one user may be different from the toll price that is shown to a second user. This may be true even if both the users are driving the same type of vehicles and are driving at the same time of the day.

The one or more inputs or data feeds used by the platform 202 to dynamically adjust a toll price for a toll road include, but are not limited to, real time traffic data 206, travel time and incident data on complementary roads 208, historical traffic data 210, schedule of events, flights 212, water, electricity and gas usage information 214, weather pattern information 216, user behavior and user characteristics/Value of Time (VOT) information 218, historical toll rates and historical toll bidding results 220.

Each of these parameters are explained one-by-one in the description below.

As mentioned in conjunction with FIG. 1, the platform 202 may be hosted on the server 106 that receives real-time traffic data 206 or real-time road usage information from one or more vehicles 104 that are plying or are expected to ply on a road network that contains the toll road for which the user is required to pay toll prices. In accordance with another embodiment of the present invention, the platform 202 may receive real-time traffic data 206 not only from the one or more vehicles 104 as mentioned above, but may also receive the real-time traffic data 206 from smart cameras and sensors installed on the road network 102, feedback from users, global positioning system installed on user devices, or other devices, servers or databases that may be configured to collect traffic information and send it to the platform 202. For example, a few commercial platforms/servers exist (for example, Google Maps™) that track real-time traffic data 206. In accordance with an embodiment of the present invention, the platform 202 may be connected to one of these commercial platforms/servers and may receive real-time traffic data 206 directly from them. The real-time traffic information may be received automatically by the platform 202, or based on a request sent by the platform 202 to these devices. The received real-time traffic data 206 may be regularly saved in a memory (not shown in FIG. 2) of the platform 202 for further estimation of the congestion on the road network 102.

Further, although it is mentioned above that the platform 202 is hosted on the server 106, the present invention may work equally efficiently if the platform 202 is outside of the server 106. In this case, the platform 202 may receive the real-time traffic data 206 from the server 106.

Based on the real-time traffic data 206, the platform 202 may estimate congestion on the toll road of the road network 102. Further, the platform may receive an average travel time or incident data 208 on complementary and/or competing roads from smart sensors and cameras, to estimate a potential congestion on the road connected to the toll road. For example, if the real-time traffic data 206 and/or the average travel time or incident data 208 on complementary/competing roads indicate that a lot of vehicles are heading towards the toll road, the platform 202 may estimate that the congestion on the road may be high.

The incident data mentioned above may be, for example, an accident or a large cargo vehicle breakdown reported on a competing road that is adjacent to the toll road. In this case, the platform 208 will infer that since the competing road may not be functional till the accident is cleared, additional traffic may get diverted to the toll road. Therefore, the platform 202 will determine that the congestion may increase on the toll road.

In addition, the platform 202 may have access to the historical traffic data 210, and the platform 202 may use this data to estimate the traffic flow (and hence potential congestion) on the toll road. As an example, the historical traffic data 210 may indicate that the traffic is high on weekdays at 8 AM on roads near to the toll road. The platform 202 may use this information to estimate a higher traffic around 8 AM at the toll road. In accordance with an embodiment of the present invention, the historical traffic data 210 may be received/extracted from the memory of the platform 202. Alternatively, the historical traffic data 210 may be received from one or more servers or databases coupled to the platform 202. These servers or databases may be third party commercial databases that store historical traffic patterns of a plurality of road networks.

Furthermore, the platform 202 may have access to one or more different databases or service providers that may provide information to the platform 202 related to any events (e.g. concert, play, etc.) 212 that may be scheduled near the toll road on the road network 102. Further, the information relating to the schedules of flight, transit, etc. may also be available to the platform 202 through one or more commercial databases or service providers providing such information in real-time.

The platform 202 may receive the information 212 associated with schedules of events, flights, transit etc., and use this information 212 to further estimate the congestion on the roads near the toll road. For example, if a concert is planned at 6 PM at an area whose route includes the toll road, the platform 202 may estimate higher than usual traffic after 4 PM on the toll roads.

In addition, the platform 202 may have access to water, electricity and gas usage information 214 in the area near the road network 102 (which contains the toll road). The platform 202 may use this information 214 to further estimate the congestion on the roads near the toll road. For example, the platform 202 may be configured to receive real-time information of the usage of water, electricity, and gas from respective service providers. Based on the received information, the platform 202 may determine if the flow of traffic is expected to increase at the toll road. For example, if the information 214 reveals that the water or electricity or gas usage in a particular locality increases at 6 or 7 AM in the morning, it may be inferred that the people living in the locality may be getting ready and may soon leave for office/school. The platform 202 may track this information over a period of time to determine a correlation between the said information and the traffic on the toll roads, and may then use the information to further estimate potential traffic congestion on the toll roads. In the above mentioned example, the platform 202 may estimate that the traffic from the said locality to the toll road may peak at 8 AM, and may thus estimate congestion around this time at the toll road. The received information 214 may be stored in the memory (not shown) of the platform 202 for predicting congestions in the future.

To further elaborate on the above mentioned data feed, the platform 202 may be configured to estimate the congestion based on a historical trend analysis of the water, gas, and electricity usage. For example, if the historical pattern shows that whenever the water, electricity and gas usage in the area containing the road network 102 is high, the traffic on the road also tends to be high, then the platform 202 can estimate traffic congestion whenever the usage of the utilities mentioned above goes above a predetermined threshold. As an additional feed, the platform 202 may have access to population densities (not shown in FIG. 2) of different localities near the road network 102. The information of population densities is combined with the water, gas, and electricity usage information 214 to further estimate accurate traffic flow on the road network 102. For example, if the water, gas, and electricity usage information 214 from a locality having a very high population density reveals an unusual spike, it can be estimated by the platform 202 that the traffic flow might increase substantially on the road network 102. In contrast, if the same information is for a locality with less population density, the platform 202 can estimate a marginal increase in the traffic flow.

The platform 202 may also have access to weather pattern information 216, and may use it to estimate traffic flow and hence potential traffic congestion. For example, whenever snow or heavy rain is predicted, the platform 202 may estimate traffic congestion.

The weather pattern information 214 may directly be received by the platform 202 from the Meteorological department, or may be received from third party databases or service providers who monitor weather patterns in real-time.

Using all the parameters mentioned above, the platform 202 may estimate potential traffic congestion that might be there on the one or more toll roads in the road network 102.

Further, in accordance with the embodiment of the present invention, the platform 202 has access to historical toll prices 220 for a plurality of toll roads, during different times of the day. Also, the platform 202 has access to historical toll bidding results 220 from different users who were shown different toll prices in the past. The historical toll bidding results 220 include details of the past toll prices that were shown to different users for different toll roads, and the details of their “reactions” to those toll prices. The “reactions” here means their bidding results. For example, as mentioned in the description of FIG. 1, the users are shown toll prices and they can “bid” on the toll prices. This means, they can either “accept” the shown toll prices and pay them, or may change their travel route and then “reject” the shown toll prices. The historical toll rates and the historical bidding information 220 may be stored in the memory of the platform 202, and the platform 202 may directly receive it from the memory. Alternatively, the platform 202 may receive the historical toll rates and the historical bidding information 220 from one or more other servers or platforms dedicatedly storing such information.

Now, based on the estimated traffic congestions, the historical toll prices at different toll roads at different times and days, and the historical toll bidding results, the platform 202 estimates a toll price for the toll road that may be shown to the user 204. This concept can be understood with the help of an example.

As an example, as shown in FIG. 2, the user 204 may be using a mobile phone 222 that may have an app installed on it for receiving the latest toll prices. The app may be connected to the platform 202. When user 204 accesses the app on his mobile phone 222, he may be able to send a request to the platform 202 to receive the latest toll prices. The request may be in the form of a travel route, or may be an explicit request for the toll prices at a particular toll road. For example, consider that the user 204 wants to travel to Destination position ‘X’ from a Start position ‘A’. The user 204 may input these positions on the app and send a request to the platform 202 to determine the “cost of the travel” or “routes”. The user 204 may also input the date and time of his travel.

Once the platform 202 receives this request, it determines one or more possible routes that the user 204 can take to travel from ‘A’ to ‘X’, and the associated cost and travel time for each route. For example, the platform 202 may determine two routes for the user—one which includes travel through the toll road, and second which avoids the toll road. The platform 202 may send the information of the two routes to the mobile phone 222, along with the associated cost and the travel times. As an example, the route through the toll road may be expensive, but the travel time may be lesser than the second route (which avoids the toll road).

Now, while showing the cost associated with the route through the toll road, an “initial” toll price associated with the toll road for the user 204 is shown to him. As mentioned above, this initial toll price is determined by the platform 202 based on the estimated traffic congestion, historical toll prices at the toll road (and other toll roads) at different times and days for different users, and the historical toll bidding results.

In accordance with another embodiment of the present invention, the platform 202, in addition, may also request additional information from the user 204 while determining the initial toll price. In accordance with an alternative embodiment of the present invention, the additional information may be stored in the memory of the platform 202. The platform 202 may also be configured to access or receive user 204's profile information from the app that is configured to access the user information. Further, platform 202 may be configured to receive the additional information from one or more third party databases or service providers.

The additional information, as mentioned above, may be one or more of, the purpose of the trip of the user 204, the budget the user 204 might be willing to spend for the trip, number of occupants that will accompany the user 204 on the trip, the vehicle that the user 204 might be using for the trip, an indication of how important the trip is for him (for example, on a grade of 1 to 5), an indication of how busy his day is (for example, on a grade of 1 to 5), and the like. Further, the platform 202 may have access to the credit card spend information of the user 204, the credit card spend information of the family members of the user 204, his club memberships (if any), the locality of his residence, his employer name and address, his designation, his past toll bidding results on a plurality of toll stations (even outside of the road network 102), frequency of usage of toll stations for different routes in the past, number of vehicles owned and registered by the user 204 on the platform 202, number of foreign or business trips made by the user 204 in the past one year, etc. Collectively, this information is shown as User behavior and characteristics/Value of time (VOT) information 220 in FIG. 2.

Through the additional information mentioned above, the platform 202 may be configured to determine how valuable “time” is for the user 204, and how much he might be willing to pay for the toll. For example, if the user indicates that the purpose of his visit is to catch a flight for an important business meeting, and the person is a CXO of a company, with healthy credit card monthly spend, it can be inferred by the platform 202 that the user 204 can pay more for the toll price, as the “value of time” for the user 204 is quite high.

Further, based on the input of the destination location, the platform 202 may itself be configured to determine the purpose of his visit, and may accordingly determine the value of time of the user 204. For example, if the location entered by the user is the location of a day care for children, then the platform 202 may infer that the value of time for the user 204 is quite high. This is because daycares are expensive, and the user 204 may want to reach before or on time to avoid paying additional cost to the daycare center. For instance, if the additional cost for daycare is 50 dollars per hour, then the user 204 can easily prefer to pay toll prices of 5 dollars (or more) to reach the daycare before or on time, to avoid paying additional cost to the daycare.

The platform 202 uses the above mentioned additional information to determine “user behavior and user characteristics” of the user 204. This information may be supplemented with the information of estimated traffic congestion, historical toll prices, and the historical toll bidding results to determine the initial toll price that should be shown to the user 204. In this way, the toll price that may be shown to one user may be different than a second user, even if both the users are driving on the same road at the same time.

Once the initial toll price is determined, it is then notified to the user 204 on his mobile phone 222. After receiving the initial toll price, the user 204 has an option to “bid” on the shown initial toll price. For example, the user 204 may accept the initial toll price or may reject it (for example, select the alternative route shown to him for the trip that avoids the toll road). The “bid” from the user 204 is then sent back to the platform 202.

Once the platform 202 receives the bid result from the user 204, and also from other users who are planning to take roads near the toll road, the platform 202 may further update its estimate of the traffic congestion and hence adjust the toll prices (“revise” toll prices) for the next set of users. For example, if the platform 202 determines that the number of users that have accepted the initial toll prices that were offered to them (toll bid) is more than a predetermined threshold number, the platform 202 may update the toll prices higher, and for the next step of users who ask for toll prices, the higher toll prices may be shared. Alternatively, if the platform 202 determines that the number of users that have accepted the toll bid is less than the predetermined threshold, the platform 202 may decrease the toll prices for the next set of toll bids or next set of users.

In other words, apart from all the parameters and information mentioned in the description above, the platform 202 also uses current bidding results 220 on the initial toll prices to decide the revised toll prices for the next set of users who share their interest in using the roads near the toll road. The revised toll prices are then notified to the next set of users, as and when they request for the prices. A person ordinarily skilled in the art may appreciate that the revised toll prices may then act as an initial toll price for the next set of users, and the parameters such as user behavior and characteristics may also be taken into consideration to provide customized toll prices to each of the next set of users.

Further, a person ordinarily skilled in the art will appreciate that the parameters or inputs mentioned in FIG. 2 are mere examples, and more or less parameters or inputs may be used by the platform 202 to decide the toll price for the user 204. The mentioned parameters or inputs should not be construed as limiting the scope of the present invention, and the present invention can work equally efficiently with more or less parameters/inputs.

For example, one additional parameter or input may be revenue target or other considerations of the firm that is responsible for traffic management on the road network 102. For instance, if the traffic management firm has a revenue target that is 5% higher than the previous year, it may revise the toll prices to be 5% higher to meet their targets. This may be done, for example, even if there is no congestion estimated on the road network 102.

The above mentioned process utilized by the platform 202 to adjust the toll prices may have different embodiments of utility. Specifically, the platform 202 may be able to recommend different routes to the user for their destination, based on their spend capacity, value of time and real-time traffic congestion estimates based on toll price bidding results.

Further, the platform 202 may be able to service “special” requests and clear the passage leading to the toll road as a response to the special service request. For example, in the times of emergency, for example accidents or fire, emergency vehicles like ambulances, police vehicles, or fire brigades may request for a minimum level of service from the platform 202 and expect a relatively clear passage through one or more toll stations. As a response to such a request, the platform 202 may temporarily increase the toll prices significantly to dissuade users from using the toll stations, thus leading to clearing of the passage for the emergency vehicles.

As an additional embodiment, a commercial fleet carrier may request the platform 202 for recommendations for the best routes to move a large number of cargo vehicles. In this case, the platform 202 may provide an estimate to the fleet carrier of the congestion at different toll stations during different times of the day and capacity of different toll stations to handle a large number of fleet vehicles. The recommendation of the best route can take into account real-time toll bidding responses, along with the parameters and inputs mentioned in the description above.

Additionally, the platform 202 may provide a provision of providing a “fixed monthly toll level” to users who specifically ask for such a request. As an example, fleet operators may be provided a fixed monthly toll price that may get revised on a monthly basis, based on toll bidding results and other parameters described above. Also, the fixed monthly toll price may be provided in such a manner that the toll roads do not get congested, i.e., the number of such fleet vehicles are kept under a preset percentage of the capacity that the toll roads can handle.

FIGS. 3A and 3B illustrate a summarized view (flow chart 300) of the steps performed by the user 204 and the platform 202 to enable dynamic adjusting of the toll prices by the platform 202, in accordance with an embodiment of the present invention.

At step 302, the steps begin. At step 304, the user 204 provides his indication to the platform 202 that he wishes to use one or more toll roads. As described in conjunction with FIGS. 1 and 2, the user 204 may provide his indication by sending a route request or toll price request to the platform 202. Alternatively, even if the user 204 is driving on or near a toll road and has an app linked to the platform 202 installed on his mobile phone 222, the platform 202 will receive an automated indication that the user 204 wishes to use the toll road.

At step 306, the platform 202 determines the initial toll price for the toll road that is customized to the user 204. The determined toll price is then notified to the user 204. The process of determining the toll price that is customized to a particular user is already described in conjunction with FIG. 2.

At step 308, the platform 202 determines whether the user 204 is driving/in motion, or stationary. If it is the former, then at step 310, the user 204 can decide himself if he wants to use the toll road or not, based on the notified toll prices. For example, if the user 204 believes that the notified toll prices are high, he can decide to take any other road and avoid the toll road. In this case, at step 312, the platform 202 tracks the route taken by the user 204 and determines whether he has taken the route with the toll road or without the toll road. The platform 202 may track the route taken by the user 204 by use of the GPS installed in the vehicle or the user device, or by the use of the smart cameras and sensors.

On the other hand, if it is determined at step 308 that the user 204 is stationary, then at step 312, the user 204 does active bidding on the app for the toll prices that are notified to him. The process of bidding for the toll prices is already described in conjunction with FIGS. 1 and 2.

Based on the bidding results and the tracking of the users who are already in motion, at step 316, the platform 202 estimates an expected traffic on the toll road. As already explained in conjunction with FIG. 2, there are a lot other parameters that are considered by the platform 202 to estimate traffic on a toll road, and bidding results and real-time traffic tracking are just two parameters. For the sake of simplicity and to avoid duplicity of description, in FIG. 3, only the above mentioned two parameters are stated.

Once the traffic is estimated at the toll road by the platform 202, at step 318, the platform 202 checks whether the toll prices need to be revised. As mentioned earlier in FIG. 2, the toll prices may need revision based on a number of factors, including, but not limited to, estimated traffic flow/congestion, revenue or other considerations for the traffic management firm, user behavior or characteristics, special requests from emergency vehicles, and the like.

Based on the check at step 318, the platform either revises (step 320) the toll prices or keeps the toll prices (step 322) the same. In either case, for the next set of users who show interest in using the toll road, at step 324, the revised (or same) toll prices are shown to the next set of users.

At step 326, the flow chart 300 ends.

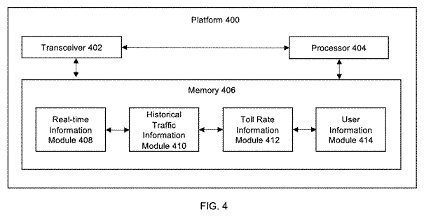

FIG. 4 illustrates a block diagram of a platform 400 (same as the platform 202 of FIG. 2), in accordance with an embodiment of the present invention. The platform 400 may include various modules such as, but not limited to, a transceiver 402, a processor 404, and a memory 406.

The memory 406 may be an integrated circuit (IC) memory chip containing any form of random-access memory (RAM) or read-only memory (ROM), a floppy disk, a compact disk read-only memory (CD-ROM), a hard disk drive, a digital video disc (DVD), a flash memory card, external subscriber identity module (SIM) card or any other medium for storing non-transitory digital information.

The memory 406 may include various modules such as, but not limited to, a real-time information module 408, a historical traffic information module 410, a toll rate information module 412, and a user information module 414. As can be understood by a person ordinarily skilled in the art, some of the modules mentioned in the memory 408 may also be outside of the memory 408 and in the platform 400, without departing from the scope of the present invention.

The transceiver 402 of the platform 400 may be configured to receive one or more inputs to dynamically adjust the toll prices for a user, which are described above in conjunction with FIG. 2. In accordance with an embodiment of the present invention, the transceiver 402 may be a receiver that may be configured to receive the one or more inputs from the multiple vehicles, devices, servers, and databases. Further, the transceiver 402 may be configured to transmit or output one or more notifications (e.g. toll routes, toll prices, etc.) to the user based on the one or more inputs. The one or more inputs include, but are not limited to, real time traffic data, travel time and incident data on complementary roads, historical traffic data, schedule of events, flights, water, electricity and gas usage information, weather pattern information, user behavior and user characteristics/Value of Time (VOT) information, historical toll rates and historical toll bidding results.

As and when the above-mentioned one or more inputs are received by the transceiver 402, they may be stored in the memory 406 of the platform 400, and may be processed by the processor 404. The processor 404 may be configured to access and process the one or more inputs received by the transceiver 402.

The processor 404 may include one or more microprocessors, microcontrollers, digital signal processors (DSPs), state machines, logic circuitry, or any other device or devices that process information based on operational or programming instructions. Such operational or programming instructions may be stored in the memory 406. One of ordinary skill in the art will recognize that when the processor 404 has one or more of its functions performed by a state machine or logic circuitry, the memory 406 containing the corresponding operational instructions can be embedded within the state machine or logic circuitry.

In accordance with an embodiment of the present invention, the processor 404 may be configured to command the real-time information module 408 to request various vehicles, devices, servers, and database (as described in FIGS. 1 and 2) to provide real-time information to the platform 400, in order to estimate the congestion on the road network 102. For example, the current location of vehicles may be fetched from smart cameras and sensors installed in the road network 102, and/or GPS installed in vehicles and user devices, weather patterns from meteorological department, schedule of events, flights and transit from respective service providers etc. As and when the information is received, the information gets stored in the memory 406 of the platform 400, and the processor 404 may be configured to estimate the congestion on the road network 102.

In accordance with further embodiment of the present invention, the processor 404 may be configured to command the historical traffic information module 410 to receive the historical traffic data from one or more servers and database, in order to further estimate the conjunction on the road network, as described above in conjunction with FIGS. 1 and 2. These servers or databases may be third party commercial databases that store historical traffic patterns of a plurality of road networks. As and when the information is received, the information gets stored in the memory 406 of the platform 400, and the processor 404 may be configured to estimate the congestion on the road network 102.

In accordance with further embodiment of the present invention, the processor 404 may be configured to command the toll rate information module 412 to receive historical toll prices for a plurality of toll stations from one or more other servers and platform, including the toll road, during different times of the day. Further, the processor 404 may be configured to command the toll rate information module 412 to receive the historical toll bidding results. As and when the information is received, it is stored in the memory 406 of the platform 400, and the processor 404 may be configured to correlate the estimation of the congestion with the received historical toll prices and historical bidding results, and estimate a toll price for the toll road that may be notified to the user, using the app, through the transceiver 402.

In accordance with further embodiment of the present invention, the processor 404 may be configured to command the user information module 414 to receive User behavior and characteristics/Value of time (VOT) information, as described above in conjunction with FIG. 2. For example, the User behavior and characteristics/Value of time (VOT) information may include, but not limited to, purpose of the trip of the user, the budget the user might be willing to spend, an indication of how important the trip is for him, an indication of how busy his day is, credit card spend information of the user, the credit card spend information of the family members of the user, his club memberships (if any), the locality of his residence, his employer name and address, his designation, his past toll bidding results on a plurality of toll stations (even outside of the road network 102), frequency of usage of toll stations for different routes in the past, number of vehicles owned and registered by the user on the platform 400, number of foreign or business trips made by the user 400 in the past one year, etc.

As and when the above-mentioned information is received, the processor 404 may be configured to determine how valuable “time” is for the user, and how much he might be willing to pay for the toll, and accordingly estimate the toll price for the toll road.

Based on the received information, the platform 400 estimates an “initial” toll price for the toll road for a particular user, and then the transceiver 402 sends the toll price to the user. As described in conjunction with FIG. 2, the user can then bid on the shown toll price, and can decide to accept or reject it. The user can then send his bid back to the platform 400 via the transceiver 402.

The received bids from one or more users are stored in the toll rate information module 412, from where the processor 404 may access them. Based on the received bids, the processor 404 may further revise the traffic congestion estimate and send a revised toll price to the next set of users who show interest in using the toll road.

The entire process of revising/updating the toll prices based on toll bids and one or more inputs is already explained in conjunction with FIG. 2, and is not explained again in FIG. 4 to avoid duplicity.

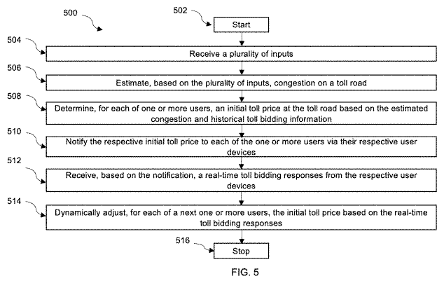

FIG. 5 illustrates a method 500 performed by the platform 400, in accordance with an embodiment of the present invention. At step 502, the method 500 begins. At step 504, the platform 400 receives a plurality of inputs to estimate congestion on a toll road. The plurality of inputs are already described above in conjunction with FIGS. 1 and 2. For instance, the plurality of inputs may include, but are not limited to, real time traffic information, user behavior, historical traffic information, accident information, weather patterns, time of the day, schedule of flight, transit, and events, usage of water, electricity and gas, traffic on complementary and competing roads, etc. and their combination thereof.

Once the plurality of inputs are received, the method moves to step 506. At step 506, the platform 400 estimates congestion on the toll road. Based on the estimation of the congestion and historical toll bidding information, the platform 400 determines an initial toll price for each of one or more users at step 508. As mentioned above, the historical toll bidding information includes bidding responses from a plurality of users on different toll prices at different toll roads in the past.

As step 510, the platform 400 notifies the respective toll price to each of the one or more respective user devices. Based on the notification of the respective toll price, the platform 400 receives real-time bidding responses from each of the one or more users through their respective user devices at step 512.

After receiving the real-time bidding responses, the method moves to step 514. At this step 514, the platform 400 dynamically adjusts the initial toll price for the toll road for each of a next one or more users, based on the real-time toll bidding responses. The dynamic adjustment of the initial toll price may include determining whether the number of users accepting the bid is greater than a predetermined threshold or whether the revenue of the toll road operators is greater than a predetermined threshold, and the like. There could be other considerations as well to adjust the toll prices. A few examples of these considerations are already mentioned in FIG. 2.

The method ends at 516.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method described herein. Alternatively, some or all functions could be implemented by a state machine that has no stored program instructions, or in one or more application specific integrated circuits (ASICs), in which each function or some combinations of certain of the functions may be implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM, a Programmable Read Only Memory (PROM), an Erasable Programmable Read Only Memory (EPROM), an Electrically Erasable Programmable Read Only Memory (EEPROM) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. The present disclosure may be realized in hardware, or a combination of hardware and software. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

I/we claim:

1. A platform for dynamically adjusting a toll price for a toll road, the platform comprising:
a transceiver configured to:
receive a plurality of inputs to estimate congestion on the toll road; and
receive a request from one or more users to provide prices of the toll road; and
a processor communicatively coupled to the transceiver, wherein the processor is configured to:
estimate, based on the plurality of inputs, the congestion on the toll road; and
determine, for each of the one or more users, an initial toll price at the toll road based on the estimated congestion on the toll road and historical toll bidding information, wherein the historical toll bidding information comprises bidding responses from a plurality of users on different toll prices at different toll roads in the past;
wherein the transceiver is further configured to:
notify the respective initial toll price to each of the one or more users via their respective user devices; and
receive real-time toll bidding responses from the respective user devices associated with the one or more users on the respective initial toll price;
wherein the processor is further configured to dynamically adjust the initial toll price for the toll road, for each of a next one or more users, based on the real-time toll bidding responses.

2. The platform of claim 1, wherein the transceiver is further configured to notify the adjusted toll price to each of the next one or more users, and receive further real-time bidding responses on the adjusted toll price.

3. The platform of claim 1, wherein the plurality of inputs comprise real time traffic information, user behavior, historical traffic information, accident information, weather patterns, time of the day, schedule of flight, transit, and events, usage of water, electricity and gas, traffic on complementary and competing roads, and their combination thereof.

4. The platform of claim 3, wherein the user behavior includes one or more of: frequency of usage of toll roads for different routes, purpose of travel, number of vehicles registered to a user profile, location of the destination, and value of time of the user.

5. The platform of claim 1, wherein the processor is further configured to recommend one or more of time and route to a user, of the one or more users, based on the plurality of inputs and the real-time toll bidding responses.

6. The platform of claim 1, wherein the transceiver is further configured to receive a first request to provide a clear passage at the toll road.

7. The platform of claim 6, wherein the first request is received from one or more of an emergency vehicle, a police vehicle, and a fire brigade.

8. The platform of claim 6, wherein the processor is further configured to dynamically adjust the initial toll price for the next one or more users based on the received first request.

9. The platform of claim 1, wherein the transceiver is further configured to receive a second request to move a large number of vehicles through the toll road.

10. The platform of claim 9, wherein the processor is further configured to notify, based on the second request, one or more of: an estimated congestion at different times, a capacity of the toll road at different times to handle the movement of the large number of vehicles, recommendation of route and time based on the plurality of inputs and real-time bidding responses.

11. A method for dynamically adjusting a toll price for a toll road, the method comprising:
receiving a plurality of inputs to estimate congestion on a toll road;
receiving a request from one or more users to provide prices of the toll road;
estimating, based on the plurality of inputs, the congestion on the toll road;
determining, for each of the one or more users, an initial toll price at the toll road based on the estimated congestion on the road and historical toll bidding information, wherein the historical toll bidding information comprises bidding responses from a plurality of users on different toll prices at different toll roads in the past;
notifying the initial toll price to each of the one or more users via their respective user devices;
in response to the notification, receiving real-time toll bidding responses from the respective user devices associated with the one or more users on the respective initial toll price; and
dynamically adjusting the initial toll price for the toll road, for each of the next one or more users, based on the real-time toll bidding responses.

12. The method of claim 11 further comprises notifying the adjusted toll price to each of the next one or more users, and receiving further real-time bidding information on the adjusted toll price.

13. The method of claim 11, wherein the plurality of inputs comprise real time traffic information, user behavior, historical traffic information, accident information, weather patterns, time of the day, schedule of flight, transit, and events, usage of water, electricity and gas, traffic on complementary and competing roads, and their combination thereof.

14. The method of claim 13, wherein the user behavior includes one or more of: frequency of usage of toll roads for different routes, purpose of travel, number of vehicles registered to a user profile, location of the destination, and value of time of the user.

15. The method of claim 11 further comprises recommending one or more of time and route to a user, of the one or more users, based on the plurality of inputs and the real-time toll bidding responses.

16. The method of claim 11 further comprising receiving a first request to provide a clear passage at the road associated with the toll road.

17. The method of claim 16, wherein the first request is received from one or more of an emergency vehicle, a police vehicle, and a fire brigade.

18. The method of claim 16 further comprises dynamically adjusting the initial toll price for the next one or more users based on the received first request.

19. The method of claim 11 further comprising receiving a second request to move a large number of vehicles through the toll road.

20. The method of claim 19 further comprising notifying, based on the second request, one or more of: an estimated congestion at different times, a capacity of the toll road at different times to handle the movement of the large number of vehicles, recommendation of route and time based on the plurality of inputs and real-time bidding responses.
